(19) United States
(12) Patent Application Publication
(10) Pub. No.: US 2014/0208535 A1
(43) Pub. Date: Jul. 31, 2014

(54) WINDSHIELD WIPER SYSTEM

(71) Applicant: Tim Sharp, Killeen, TX (US)

(72) Inventor: Tim Sharp, Killeen, TX (US)

(21) Appl. No.: 13/753,571

(22) Filed: Jan. 30, 2013

(51) Int. Cl. B60S 1/50

(52) U.S. Cl. CPC B60S 1/50
USPC 15/250.04

(57) ABSTRACT

A windshield wiper system that includes a pair of windshield wiper blades movably positioned on an exterior surface of a windshield of a vehicle, a piece of windshield wiper fluid tubing that allows windshield wiper fluid to be transmitted to reach the pair of windshield wiper blades and a pump positioned inside the piece of windshield wiper fluid tubing. The system also includes a recyclable hard plastic receptacle with a top orifice that contains the windshield wiper fluid that is pumped by the pump through the piece of windshield wiper fluid tubing and a screw cap that removably connects the second end of the piece of windshield wiper fluid tubing to the top orifice of the receptacle. The pump can also be located outside of the piece of windshield wiper fluid tubing.

### TECHNICAL FIELD & BACKGROUND

Currently there have been limited improvements to the process of maintaining wiper fluid capacity. Those who have to pour windshield wiper fluid into a standardized windshield washer fluid pump tend to experience the unpleasant incident of windshield wiper fluid splashing, often staining their clothes and other materials.

The present invention generally relates to an automotive device system. More specifically, the invention is a windshield wiper system.

It is an object of the invention to provide a windshield wiper system that prevents spillage of any windshield wiper fluid being poured into the windshield wiper system.

It is an object of the invention to provide a windshield wiper system that includes a receptacle that can be recycled.

It is an object of the invention to provide a windshield wiper system that pumps windshield wiper fluid out of a receptacle against a firewall of the vehicle.

What is needed is windshield wiper system that prevents spillage of any windshield wiper fluid being poured into the windshield wiper system that includes a receptacle that can be recycled that pumps windshield wiper fluid out of a receptacle against a firewall of the vehicle.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a windshield wiper system, according to an embodiment of the present invention.

FIG. 2 illustrates a front view of a windshield wiper system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

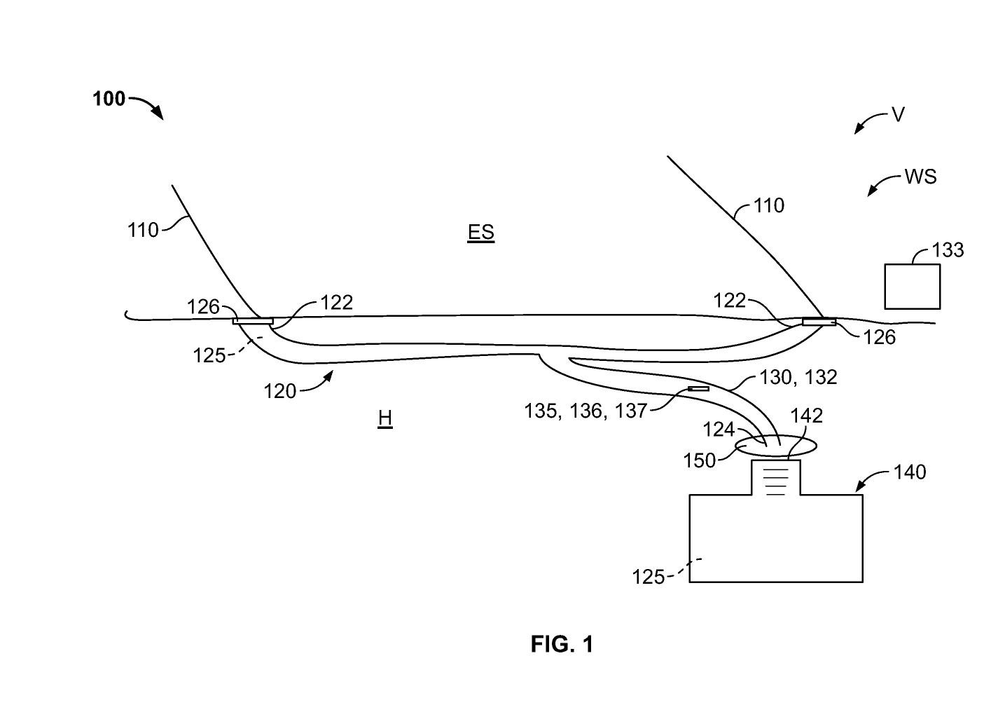

FIG. 1 illustrates a front view of a windshield wiper system 100, according to an embodiment of the present invention.

The windshield wiper system 100 includes a pair of windshield wiper blades 110, a piece of windshield wiper fluid tubing 120, a pump 130, a receptacle 140 and a screw cap 150. The windshield wiper system 100 is placed underneath a hood H of a vehicle V.

The pair of windshield wiper blades 110 are movably positioned on an exterior surface ES of a windshield WS of a vehicle V to wipe and clean the exterior surface ES of the windshield WS of the vehicle V. The pair of windshield wiper blades 110 is typically made of durable rubber but can be made of any suitable material. The piece of windshield wiper fluid tubing 120 has a pair of first ends 122 and a second end 124 and allows windshield wiper fluid 125 to be transmitted to reach the pair of windshield wiper blades 110. The piece of windshield wiper fluid tubing 120 can be made of transparent plastic tubing, non-transparent plastic tubing or other suitable material. The pair of first ends 122 of the piece of windshield wiper fluid tubing 120 are each attached to a disperser device 126 adjacent to the pair of windshield wiper blades 110. The disperser device 126 is positioned in front of the windshield WS and disperses the windshield wiper fluid 125 that is transmitted through the piece of windshield wiper fluid tubing 120 onto the windshield WS to facilitate cleaning the windshield WS. The disperser device 126 has one or more orifices (not shown) to disperse the windshield wiper fluid 125 and can be any suitable type of disperser device made of any suitable type of material. The pump 130 is positioned inside the piece of windshield wiper fluid tubing 120 to pump the windshield wiper fluid 125 through the piece of windshield wiper fluid tubing 120 to be dispersed by the disperser device 126. The pump 130 is an electrical pump 132 but can be any suitable type of pump that can be positioned inside the piece of windshield wiper fluid tubing 120. The electric pump 132 is powered by a selected one of a vehicle battery 133 and one or more portable batteries 135. The one or more portable batteries 135 can be one or more alkaline batteries 136, one or more lithium batteries 137 or any other suitable type or size of portable batteries. The receptacle 140 has a top orifice 142 that contains the windshield wiper fluid 125 that is pumped by the pump 130 through the piece of windshield wiper fluid tubing 120. The receptacle 140 is made of recyclable hard plastic that can be recycled to save hard plastic resources, to eliminate a need to produce additional hard plastic and to prevent additional pollution. The receptacle 140 is manufactured according to a vehicle year and a vehicle model of the vehicle V. The screw cap 150 removably connects the second end 124 of the piece of windshield wiper fluid tubing 120 to the top orifice 142 of the receptacle 140. The screw cap 150 can also be unscrewed and removed to refill the receptacle 140 with windshield wiper fluid 125.

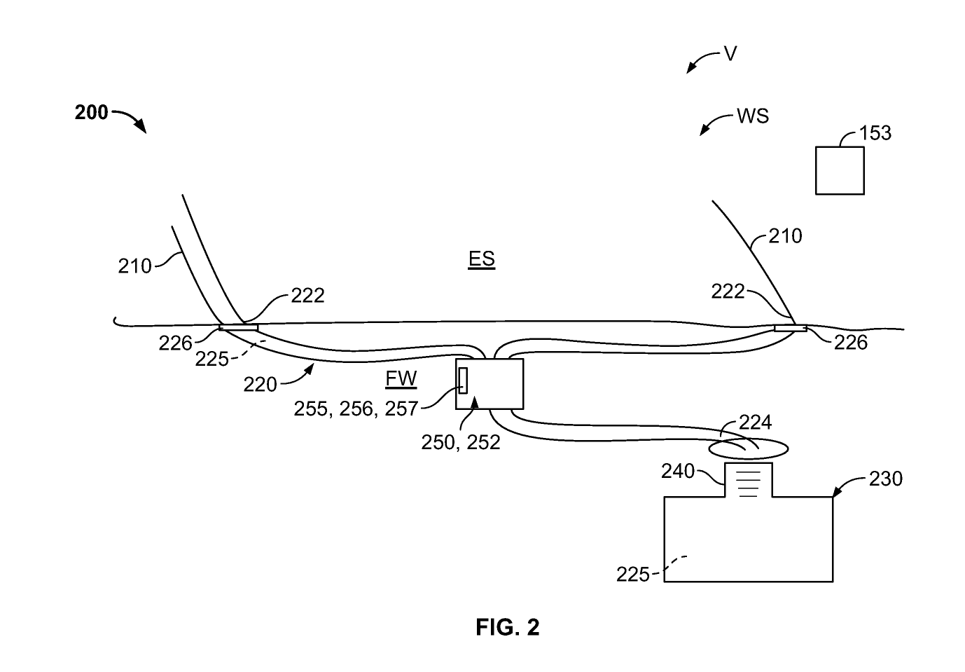

FIG. 2 illustrates a front view of a windshield wiper system 200, according to an embodiment of the present invention.

The windshield wiper system 200 illustrated in FIG. 2 includes a pair of windshield wiper blades 210, a piece of windshield wiper fluid tubing 220, a receptacle 230 and a screw cap 240 that is similar to the windshield wiper system 100, the pair of windshield wiper blades 110, the piece of windshield wiper fluid tubing 120, the receptacle 140 and the screw cap 150 illustrated in FIG. 1.

In contrast to FIG. 1, FIG. 2 illustrates an exterior pump 250 that receives a pair of first ends 222 and a second end 224 of the piece of windshield wiper fluid tubing 220 and allows windshield wiper fluid 225 to be transmitted to reach the pair of windshield wiper blades 210. The exterior pump 250 is positioned outside the piece of windshield wiper fluid tubing 220 to pump the windshield wiper fluid 225 through the piece of windshield wiper fluid tubing 220 to be dispersed by a disperser device 226. The exterior pump 250 is an electrical pump 252 but can be any suitable type of pump that can be positioned outside the piece of windshield wiper fluid tubing 220. The electric pump 252 is powered by a selected one of a vehicle battery 253 and one or more portable batteries 255. The one or more portable batteries 255 can be one or more alkaline batteries 256, one or more lithium batteries 257 or any other suitable type or size of portable batteries. Typically the exterior pump 250 is removed from the receptacle 230 and positioned against a firewall FW of a vehicle V.

The windshield wiper system introduces a controlled method to replacing windshield wiper fluid. Removing the pump from the receptacle and positioning it against the firewall of a vehicle, the windshield wiper system permits a user to simply screw the fluid-filled receptacle's cap off and attach a plurality of pump wires directly to the top of the windshield wiper system. With each receptacle manufactured according to the year and model of a vehicle, the windshield wiper system fits securely under the hood of a vehicle for prompt installation. The windshield wiper system is also possessing ecofriendly benefits since the receptacle is spill-free and easily recyclable. The feature of a pump-free fluid filled receptacle, that simplifies windshield wiper maintenance while supporting the same level of high performance as a traditional wiper fluid receptacle, may become seen as an industry standard.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A windshield wiper system, comprising:
a pair of windshield wiper blades movably positioned on an exterior surface of a windshield of a vehicle, the pair of windshield wiper blades to wipe and clean the exterior surface of the windshield of the vehicle;
a piece of windshield wiper fluid tubing with a pair of first ends and a second end, the piece of windshield wiper fluid tubing allows windshield wiper fluid to be transmitted to reach the pair of windshield wiper blades, the pair of first ends of the piece of windshield wiper fluid tubing are each attached to a disperser device adjacent to the pair of windshield wiper blades;
a pump positioned inside the piece of windshield wiper fluid tubing, the pump pumps the windshield wiper fluid through the piece of windshield wiper fluid tubing dispersed by the disperser device;
a recyclable hard plastic receptacle with a top orifice, the recyclable hard plastic receptacle contains the windshield wiper fluid that is pumped by the pump through the piece of windshield wiper fluid tubing, the recyclable hard plastic receptacle is recycled to save a plurality of hard plastic resources, to eliminate a need to produce additional hard plastic and to prevent additional pollution; and
a screw cap that removably connects the second end of the piece of windshield wiper fluid tubing to the top orifice of the receptacle, the screw cap is unscrewed and removed to refill the receptacle with windshield wiper fluid.

2. The windshield wiper system according to claim 1, wherein the pair of windshield wiper blades is made of durable rubber.

3. The windshield wiper system according to claim 1, wherein the dispenser device is positioned in front of the windshield, the dispenser device disperses the windshield wiper fluid that is transmitted through the piece of windshield wiper fluid tubing onto the windshield to facilitate cleaning the windshield.

4. The windshield wiper system according to claim 1, wherein the piece of windshield wiper fluid tubing is made of transparent plastic tubing.

5. The windshield wiper system according to claim 1, wherein the piece of windshield wiper fluid tubing is made of non-transparent plastic tubing.

6. The windshield wiper system according to claim 1, wherein the pump is an electrical pump.

7. The windshield wiper system according to claim 6, wherein the pump is powered by a vehicle battery.

8. The windshield wiper system according to claim 6, wherein the pump is powered by one or more portable batteries.

9. The windshield wiper system according to claim 8, wherein the one or more portable batteries are a selected one of one or more alkaline batteries and one or more lithium batteries.

10. The windshield wiper system according to claim 1, wherein the recyclable hard plastic receptacle is manufactured according to a vehicle year and a vehicle model of the vehicle.

11. A windshield wiper system, comprising:
a pair of windshield wiper blades movably positioned on an exterior surface of a windshield of a vehicle, the pair of windshield wiper blades to wipe and clean the exterior surface of the windshield of the vehicle;
a piece of windshield wiper fluid tubing with a pair of first ends and a second end, the piece of windshield wiper fluid tubing allows windshield wiper fluid to be transmitted to reach the pair of windshield wiper blades, the pair of first ends of the piece of windshield wiper fluid tubing are each attached to a disperser device adjacent to the pair of windshield wiper blades;
an exterior pump that receives the pair of first ends and the second end of the piece of windshield wiper fluid tubing, the exterior pump allows the windshield wiper fluid to be transmitted to reach the pair of windshield wiper blades, the exterior pump is positioned outside the piece of windshield wiper fluid tubing to pump the windshield wiper fluid through the piece of windshield wiper fluid tubing dispersed by the disperser device;
a recyclable hard plastic receptacle with a top orifice, the recyclable hard plastic receptacle contains the windshield wiper fluid that is pumped by the exterior pump through the piece of windshield wiper fluid tubing, the recyclable hard plastic receptacle is recycled to save a plurality of hard plastic resources, to eliminate a need to produce additional hard plastic and to prevent additional pollution; and
a screw cap that removably connects the second end of the piece of windshield wiper fluid tubing to the top orifice of the receptacle, the screw cap is unscrewed and removed to refill the receptacle with windshield wiper fluid.

12. The windshield wiper system according to claim 11, wherein the pair of windshield wiper blades is made of durable rubber.

13. The windshield wiper system according to claim 11, wherein the dispenser device is positioned in front of the windshield, the dispenser device disperses the windshield wiper fluid that is transmitted through the piece of windshield wiper fluid tubing onto the windshield to facilitate cleaning the windshield.

14. The windshield wiper system according to claim 11, wherein the piece of windshield wiper fluid tubing is made of transparent plastic tubing.

15. The windshield wiper system according to claim 11, wherein the piece of windshield wiper fluid tubing is made of non-transparent plastic tubing.

16. The windshield wiper system according to claim 11, wherein the exterior pump is an electrical pump.

17. The windshield wiper system according to claim 16, wherein the exterior pump is powered by a vehicle battery.

18. The windshield wiper system according to claim 16, wherein the exterior pump is powered by one or more portable batteries.

19. The windshield wiper system according to claim 18, wherein the one or more portable batteries are a selected one of one or more alkaline batteries and one or more lithium batteries.

20. The windshield wiper system according to claim 11, wherein the recyclable hard plastic receptacle is manufactured according to a vehicle year and a vehicle model of the vehicle.
